(19) United States
(12) Patent Application Publication
(10) Pub. No.: US 2009/0184170 A1
(43) Pub. Date: Jul. 23, 2009

(54) PCB rotating gift card

(76) Inventors: Timothy Clegg, Manhattan Beach, CA (US); Satyajit Deb, Plainfield, IL (US)

Correspondence Address: LAW OFFICES OF CLEMENT CHENG, 17220 NEWHOPE STREET #127, FOUNTAIN VALLEY, CA, 92708, US

(21) Appl. No.: 12/009,907

(22) Filed: Jan. 23, 2008

(51) Int. Cl. G06K 19/06

(52) U.S. Cl. 235/494

(57) ABSTRACT

A stored value card has a housing including an upper shell and lower shell forming a space between the shells, wherein the housing forms a slot shaped to receive a card. A rotating element has a graphic image imprinted on the disc. The rotating element rotates by electrical motor. The upper shell has a window allowing viewing of at least a portion of the rotating element. A speaker element provides sound. An account identifier signifying a financial account is linked to the stored value card, and the account identifier is on the housing. An electronic controller may supply three phases to a first and a second coil groups for at least a pair of coils. The three phases supplied to each of the pair of coils are a North phase, a South phase, and a neutral phase on a first coil, a second coil and a third coil.

### DISCUSSION OF RELATED ART

Stored value cards referred to as visa cards, debit cards, credit cards, gift cards or pre-paid cards in the retail market contain manually or electronically retrievable monetary values in them and are used as indirect payment methods between the issuing merchants and the customers in purchasing the merchant products or services. They are great for offering goods and services as gifts where cash exchanges are not preferred over thoughtful presentation of a value card, which also provides good range of freedom for the card holder to choose her or his desired item in the store that the card giver selected.

The values stored may be only a dollar or at any increments set by the issuer and agreed upon by the card customer who initially pays for the card value. So, the indistinctive shape of card may have one of a wide range of money amounts printed or written on an appropriate space of the card itself. Oftentimes, there is no monetary amount printed on the card.

Unfortunately, when the stored value has been spent, the cards are normally tossed away because the actual card may have no value. This can be against the gift a givers' wish that their gestures be remembered along with what they gave, in this case the card itself. There have been efforts to provide more expressive stored value cards by individual merchants to promote such card transactions and increase sales. An improvement to the existing cards was to change the package adapted to hold the card in merchandising display at the stores into more attractive designs to transfer between individuals.

The gift card has become a prominent replacement of the paper gift certificate which retail stores and restaurants offered pre-gift cards era. Gift cards are more favorable than gift certificates for many various reasons. Gift certificates take time to issue, track and redeem. Normally, gift certificates are kept in restricted areas in the store that is accessible only to the store manager or owner, who has the authority to issue the gift certificate. Issuing the gift certificate requires accounting and authorizing activity that delay and interrupt the checkout process. Once lost, the gift certificate is not replaceable and shoppers have no recourse. Furthermore, fraud and counterfeiting are more likely with gift certificates because they can be stolen or forged. Gift certificates are not marketed well either, since unlike gift cards that are publicly displayed and well-advertised at the checkout counter, gift certificates are placed out of the consumer's sight and kept securely in cash register drawers.

Beginning in 1995, retailer companies like began testing gift cards. In its first year on the market, the gift card grossed $1 billion in sales. By 2003, the gift card market grew to $45 billion. Today, more than 50% of retailers have jumped onto the gift card bandwagon, thereby increasing sales to more than $70 billion per year.

The gift card is a gift. Instead of buying a present, the gift giver purchases a gift card as a gift. The gift card bears some resemblance to a credit card. It's almost like a credit card that has many restrictions. Like a credit card, the gift card is a substitute for currency in the form of credit. Physically, it is a small plastic card that looks like a traditional credit card. It also has a barcode or magnetic strip that is processed through a standard electronic credit card machine. Issuers of the gift card include credit card companies, retail stores, banks, restaurants, and many other types of institutions and businesses. The recipient of a gift card uses the card to make purchases at the issuing company's locations.

The gift card has no value before it is purchased and activated, which creates no significant financial loss for the issuer if the card is stolen. The card obtains value only when the customer purchases the card or when the cashier enters the amount the customer wishes to place on the card. It can be purchased in the store and through store catalogues. It can also be purchased online, in which case an electronic gift card is issued via email to the gift recipient. The electronic gift card is a clever invention because, the recipient of an electronic gift card is able to receive the card instantly and the purchaser of the gift card does not have to incur any shipping charges. Once a gift card is purchased, the card's value is saved in the store's database, that is then cross-linked to the card's ID for tracking purposes. A gift card is usually available in set amounts such as $5, $10, $25, $50, $100, or $500. Sometimes, a gift card can be purchased for any random amount depending on the individual issuing company's policies. For example, one could purchase a gift card for the amount of $32 to give to someone as a gift for their 32^{nd} birthday. To make the gift card more personable, there is normally room on the card to add a personalized message for the gift recipient.

There is usually no transaction fee to purchase a gift card. However, some card providers will charge maintenance fees, which are absorbed by the card user or card recipient. Particularly, some cards depreciate usually after 2 years from the date of purchase and providers charge a small fee per month, e.g. $2.50 a month. Some cards have expiration dates that take effect usually after 24 months of inactivity. These maintenance fees are subject to various local state regulation. There is an increasing trend to eliminate maintenance fees and expiring cards in an effort to increase retail sales as well as consumer satisfaction. In cases where cards to do not expire or depreciate, unused balances on the card remain on the card until the balance is spent. Most gift cards can also be reloaded after the balance on the card is spent.

Traditionally, a gift card is redeemable only at the issuing company. Yet, some companies are now seeking the multi-channel route by issuing a segmented gift card. This type of card allows one to use the card at a number of unrelated retailers, thereby reducing the number of cards one has to carry around. For example, some local supermarkets issue gift cards that can be used at several different retailers. The participating retailers' logos are usually labeled right on the gift card for reference. Gift cards issued by credit card companies, like VISA, MasterCard, and American Express provide even broader usage. For example, a VISA gift card can be redeemed at any location where a VISA credit card is accepted.

Besides creating many different and innovative ways to use a gift card, card providers are now revamping the aesthetics and the presentation of gift cards. No longer is the gift card a dull plastic card labeled simply with the card provider's name or logo. Today, the gift card can be a small piece of artwork or fascinating object of entertainment, as card providers continue to come up with new and interesting ways to design their gift cards.

Some retailers have become very creative card providers with over 16 designs for gift cards suited for various seasons, holidays and special occasions. Some of the designs are truly novel and unique. Some retailers have a gift card that can be used as a Christmas tree ornament. There are gift cards that shows a puppy rolling over back and forth. Some gift cards can be used as spa ingredient: a gift card filled with aromatic bath salts. Some gift cards are like toys: a gift card that has pop-out pieces that can be assembled. Many retailers integrate the current trends of society into their gift card designs. They make gift cards that are themed after popular movies and even make cards inspired by home video games. A retailer currently sells a gift card that turns into a transformer character from the movie, Transformers. There is also a Nintendo Wii gift card that illuminates in a blue neon light.

Some other examples of gift cards with creative designs. One retailer had a gift card that displayed the picture of the actor and musician Harry Connick, Jr. and another retailer's gift cards display holograms that show depth and motion as the viewing angle changes. Another popular design for gift cards is attaching a fancy cardboard stock that functions as a greeting card or card holder for the gift card. One can expect that gift card providers will only become more competitive and innovative with their designs.

The gift card provides huge profit margins for the retailers because it is an effective way of marketing business and bringing customers into the stores to shop. The gift card fits into the wallet like any other credit card or debit card. The store logo on the card provides a constant reminder for the customer to shop whenever the customer sees the card in the wallet. Company revenue reports show that the average card holder tends to spend more than the face value of the card when he or she uses the card, thereby generating additional sales for the retailer. Cards that can be reloaded bring the customer back into the stores for repeat shopping, thereby maintaining sales. Issuing gift cards guarantees sales and prevents the loss of profit. Unused portions of the card are always stored as credit and never refunded as cash, thereby ensuring the return of customers. If the consumer does not spend the balance of the card, the value is still in the retailer's pocket. This abandonment of the card by the consumer provides a significant area of realized profits. When balances get below a certain amount, e.g. $1.00, some customers stop using the cards. Abandoned cards could translate to millions of dollars per year in profit. Another way retailers benefit from the gift card is by using it as a promotional item to encourage savings to the consumer and to ensure return trips to the retailer. For example, some retailers have given out $10 gift cards for tire purchases. Another example is provided by where a retailer gives $80 gift cards for purchases of $200 or more.

The gift card's greatest advantage to the consumer is convenience when people have time limitations and busy schedules. Gift giving is often challenging because we don't always know what to give as a gift. Gift-giving is also a very time-consuming task, which becomes very inconvenient when we don't have the time to shop for gift. With the gift card, these problems associated with gift-giving are easily solved. Though we may not know what to buy someone, we certainly could take a good guess at where they could or would like to shop. The gift card allows us to choose a retailer where we think our gift recipient would likely find items he or she favors. And when we don't know where our recipient would like to shop, there's always the option of purchasing a gift card from places like VISA and American Express, or simply buy one of those segmented gift cards. The gift card truly offers the recipient the liberty to buy what he or she wants. This saves the recipient from being put in the position of receiving “bad” gifts. The gift card is a very marketable invention that provides a win-win scenario for both the purchaser and the gift recipient.

An improvement to the gift card suggested by the inventor in Stored Value Card With Light U.S. patent application Ser. No. 11/038,018 is equipped with a light emitting diode, which is push-button activated to emit light combined with printed graphics. The previous improvement was a success in that it included lights and sound to a gift card. The previous improvement had a first primary panel, a secondary primary panel spaced from the first primary panel. The first primary panel defines an account identifier signifying a financial accounting linked to the stored value card. A side is defined between the first primary panel and the second primary panel. The light circuit is located inside the housing and has a switch. The light extends from the side of the housing and can be eliminated by pushing the push button switch. The message cards are found to work well as contemplated. In order to contain the electronic parts, that card device came to have a modified thickness of more than ¼″ compared to normal 0.30 mil of card as accepted by most card reading machines.

### BRIEF DESCRIPTION OF THE DRAWINGS

FIG. 1 is a top view of the gift card with a the top housing removed.

FIG. 2 is a top view of the gift card with the top housing over the bottom housing.

FIG. 3 is a diagram showing the magnetization of the disc.

FIG. 4 is a cross-section diagram showing assembly of the parts of the gift card.

The following call a list of elements may assist a reader in cross-referencing elements in the following drawings.
11 top housing
12 bottom housing
14 graphic
16 axis
18 disc
19 lower section
24 North polarity
25 South polarity
30 coil group
31 first coil
32 second coil
33 third coil
34 fourth coil
35 fifth coil
36 sixth coil
38 step angle
40 circuit
41 battery
50 graphic window
101 first step
102 second step
103 third step
104 fourth step
105 fifth step
106 sixth step

### DETAILED DESCRIPTION OF THE PREFERRED EMBODIMENT

The gift card has a circular disc with a number of magnets mounted on the periphery of the circular disc. A coil group 30 having three phase construction would also be suitable for driving a disk 18.

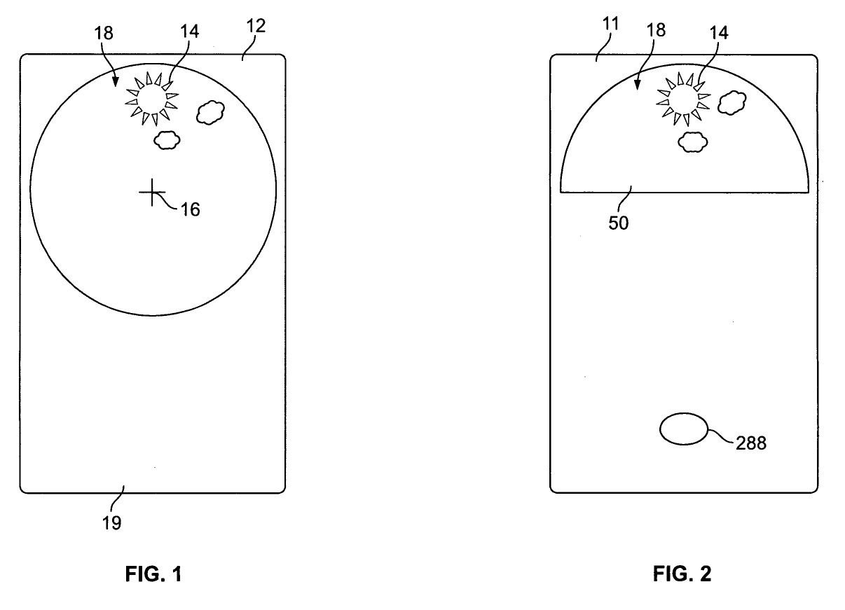

FIG. 1 is a top view of the gift card with a the top housing 11 removed. The gift card has a disc 18 rotating about an axis 16. The disc 18 has a graphic imprinted surface displaying a color graphic image 14. The bottom housing holds the axis 16 and the disc 18 that is inside the gift card. A lower section 19 holds circuitry including a circuit 40 and a battery 41 to power the circuit 40. The lower section 19 is formed of a cavity disposed between the top housing 11 and the bottom housing 12.

FIG. 2 is a top view of the gift card with the top housing 11 over the bottom housing 12. The top housing 11 has a graphic window 50 providing selective viewing of the graphics 14 printed on the disc 18. The graphic window 50 is shown here as a semicircular window providing a view of half of the disc 18. The graphic window 50 could also be in a wide variety of shapes such as a pattern of transparent dots, or a square shaped window. If the disc 18 has a solar and clouds graphic 14 on half of the disc 18, the disc 18 may have a different graphic on the other side such as a nighttime sky graphic.

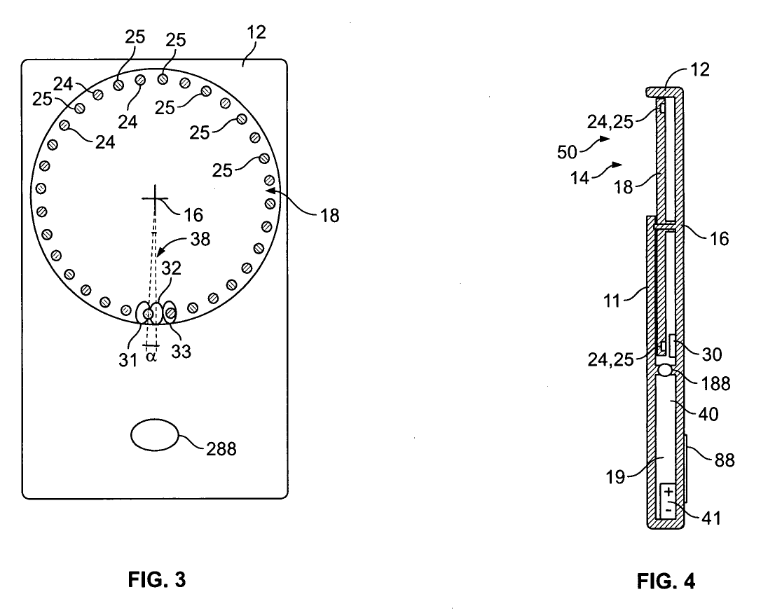

FIG. 3 is a diagram showing the magnetization of the disc. Round dots denote magnetized areas that have either a North polarity 24 or a South polarity 25. The embodiment shown in FIG. 3 shows 32 magnetization areas alternating between North and South polarity around the circumference of the disc. The magnetization areas have a North polarity 24 or South polarity 25 increments in 3.75° per step since 360° divided by 32 magnetization areas would be 11.25° per magnetization area. In each step, the disc turns 3.25° which is the step angle 38. Thus, three steps are necessary between consecutive magnetization areas.

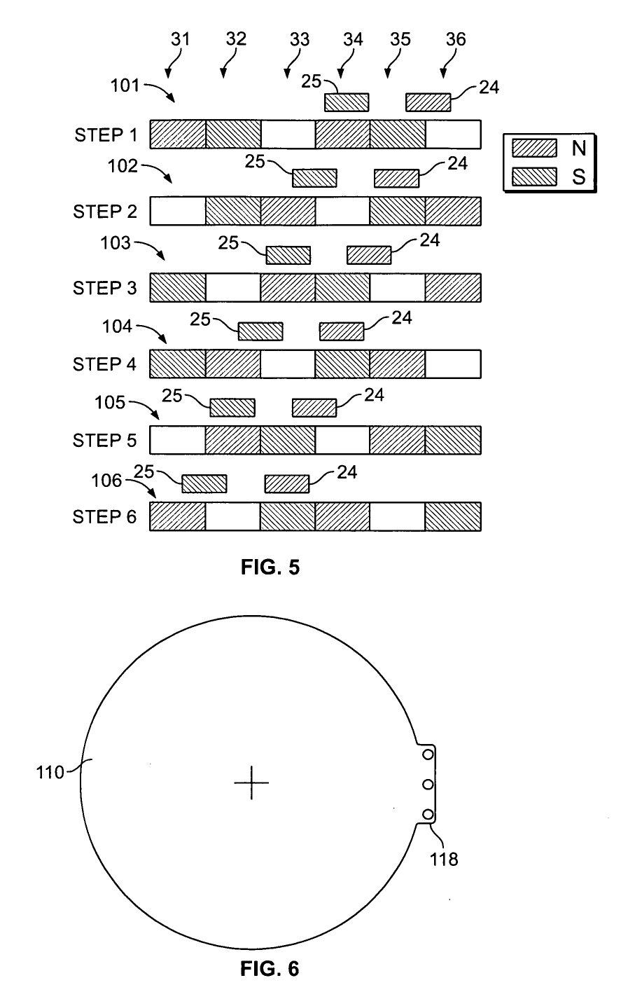

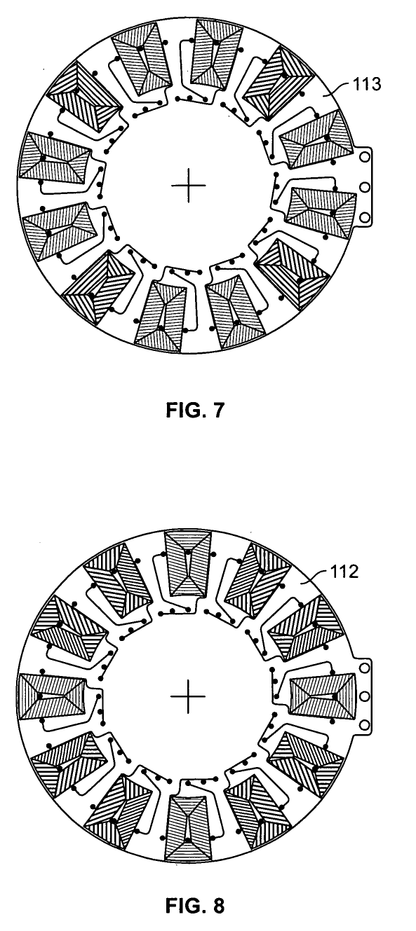

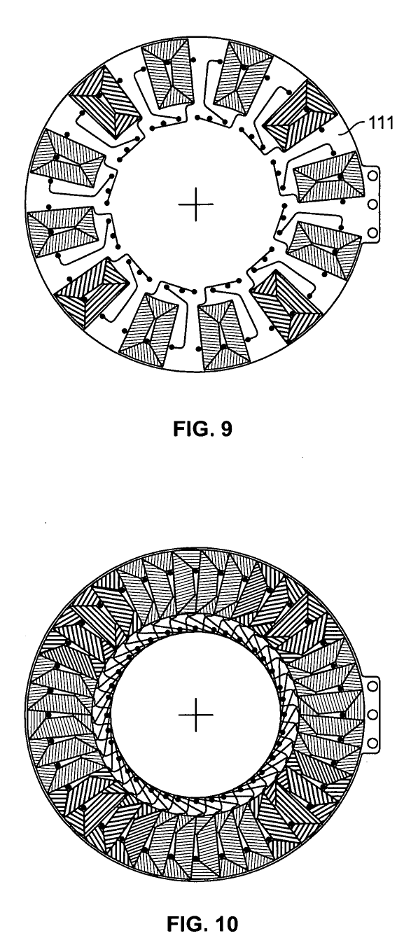

FIG. 4 is a cross-section diagram showing assembly of the parts of the gift card. The rotating disc 18 could be of a wide variety of shapes such as a square, triangle, hexagon or irregular shaped object such as an egg or flower. The disc preferably has magnetized areas on the bottom side of the disc where magnets 24, 25 are mounted. Alternatively, a disc can be made having magnetized areas so that manual labor is conserved where the magnets 24, 25 do not need to be individually drilled, and filled with magnets. A wide variety of magnet technologies can be implemented so that magnetization areas 24, 25 can be mass-produced.

The disc is mounted on the axle, optionally having a protruding tip from the bottom of the disc for stability or to reduce friction and provide clearance from components such as a coil group 30. The coil group 30 faces the magnetized areas such as the North polarity 24 or the South polarity 25 areas. A pair of coil groups can be mounted on the bottom housing 12 so that a total of six coils drive the disc 18 in a clockwise or counterclockwise direction.

The coil control is controlled by an electronic circuit 40 such as that commonly known in the industry. The coil control is preferably located in the lower section 19 which is a hollow compartment formed between the upper shell 11 and the bottom shell 12. The sidewalls of the housing provide vertical clearance for the rotating disc 18 as well as for installation of electronic circuits 40. The coil control is powered by a battery 41. Preferably, three 1.5V batteries are sufficient to power the device.

FIG. 5 shows the step diagram for the three phase six step coil control. The three phases correspond to three orientations. There is a North orientation, a South orientation and a neutral orientation. In the neutral orientation, the coil does not have current flowing through it. In the first step 101, the first coil has a North orientation, the second coil has a South orientation, the third coil has a neutral orientation, the fourth coil has a North orientation, the fifth coil has a South orientation and the sixth coil has a neutral orientation.

In the first step 101, the South polarity area 25 is mounted to the disc 18 opposes the North orientation on the fourth coil. The fourth coil is the first coil on the second set of tricoil coil groups 30. The North polarity area 25 is mounted to the disc 18 so that it is offset and between the fifth coil and the sixth coil. For purposes of clarity, only a pair of North polarity 25 and South polarity 24 areas are shown. In actual implementation, the North polarity 25 and South polarity 24 pattern continue circumferentially about the disc 18. Therefore, the two groups of coil groups 30 comprising six coils in total can be placed next to each other as shown in FIG. 5, or the first set of coils can be diametrically opposite the second set of coils.

In the second step 102, the first coil 31 has a neutral orientation, the second coil 32 has a South orientation, and the third coil 33 has a North orientation. The pattern of neutral, South, North is repeated in the second set of coils which can also be referred to as the fourth, fifth and sixth coils. The South polarity 24 of the disc is now between the third and fourth coils and the North polarity 25 is opposing the South orientation fifth coil. Thus, the disc 18 has rotated 3.75° between step one and step two.

In the third step 103, the first coil 31 has a South orientation, the second coil 32 has a neutral orientation and the third coil 33 has a North orientation. The subsequent fourth coil 34, fifth coil 35 and sixth coil 36 follow the pattern of the first three coils comprising the first coil group. This causes the South polarity 25 to oppose and attract to the third coil 33 having a North orientation, while the North polarity 24 lies between the fourth coil 34 and the fifth coil 35. Again, the disc 18 rotates 3.75° for the third step 103.

In the fourth step 104, the first coil 31 has a South orientation, but second coil 32 has a North orientation, the third coil 33 has a neutral orientation, and the subsequent fourth coil 34, fifth coil 35 and sixth coil 36 follow the pattern of the first three coils. The North polarity 24 portion is attracted to the fourth coil 34 having the South orientation. The South polarity 25 is located between the second coil 32 having a North orientation and the third coil 33. Again, the disc 18 rotates 3.75° for the fourth step 104.

In the fifth step 105, the first coil 31 has a neutral orientation, the second coil 32 has a North orientation, the third coil 33 has a South orientation, the fourth coil 34 has a neutral orientation, the fifth coil 35 has a North orientation, and the sixth coil 36 has a South orientation. The North polarity 24 portion is attracted to the third coil 33 having the South orientation so that the North polarity 24 portion is between the third coil 33 and the fourth coil 34. The South polarity 25 is located opposite and attracted to the second coil 32 having a North orientation. Again, the disc 18 rotates 3.75° for the fifth step 105.

In the sixth step 106, the first coil 31 has a North orientation, the second coil 32 has a neutral orientation, the third coil 33 has a South orientation, the fourth coil 34 has a North orientation, the fifth coil 35 has a neutral orientation, and the sixth coil 36 has a South orientation. The North polarity 24 portion is attracted and opposite to the third coil 33 having the South orientation. The South polarity 25 is located between the first coil 31 having a North orientation and the second coil 32 having a neutral orientation. Again, the disc 18 rotates 3.75° for step six 106.

After step six 106, the sequence goes back to the first step 101 and repeats for as long as the disc is turning. The disc 18 rotates 3.75° for each step. The sequence can also reverse if it is desired to reverse the rotation of the disc. As mounted, the disc would turn either clockwise or counterclockwise and the rotation could be reversed by reversing the order of steps. The steps can be paused showing discrete step movement, or can be flowing and continuous so that a user sees constant rotation.

Instead of having the North polarity 24 and South polarity 25 magnet portions on the disc 18, the coil windings such as a number of coil group 30 can be mounted on the disc while a magnet is mounted to the housing. Even though it would be conceptually simple to reverse the construction in this way, it is preferred to have the coil group 30 mounted to the bottom housing 12.

FIG. 6 shows a top view of the multiple layer circuit board 110. It is basically circular with electrical connectors 118 at the right side of the drawing. The electrical connectors 118 are represented by three dots indicating conductive metal connection points.

FIG. 7 shows the third layer 113. Layer three 113 has a total of 12 coils and each layer has 12 coils. Therefore, if there are three coils in a group, there would be 12 coil groups 30. The coils would overlap each other to have complementary magnetic field production.

FIG. 8 shows the second layer 112.

FIG. 9 shows the first layer 111.

The three layer stator can be used in conjunction with a disc 18 having a number of magnets on the disc 18. The number and spacing of magnets or North polarity 24 locations and South polarity 25 locations would be matched with the number of coils in the stator.

The layers are electrically connected to each other by electrical passages passing through the layers. Each layer can be formed independently in mass quantities and joined to the other layers using solder or any industry known technique.

FIG. 10 shows the composite view of the first layer 111, the second layer 112, the third layer 113.

The bottom housing can also receive a circuit board having a group of coils 30 printed onto the multiple layers of the circuit board. Therefore, the circuit board having the coil groups 30 can replace the coil groups 30 shown in FIG. 3 and FIG. 4.

Optionally, a lighted element 188 can light the rotating disc. Also, a speaker element 288 can produce sound when the disk is rotating. The lighted element 188 and the speaker element 288 both preferably connect to the circuit 40 so that their logical operation is controlled by the circuit 40. The circuit 40 may provide for a variety of different logical operations such as intermittent control.

1. A stored value card comprising:
a. a housing including an upper shell and a lower shell forming a space between the shells, wherein the housing forms a slot shaped to receive a card;
b. a rotating element having a graphic image imprinted on the disc, wherein the rotating element rotates by an electrical motor, wherein the upper shell has a window allowing viewing of at least a portion of the rotating element;
c. an account identifier signifying a financial account linked to the stored value card, wherein the account identifier is on the housing.

2. The stored value card of claim 1, further comprising an electronic controller supplying three phases to a first and a second coil groups for at least a pair of coils, wherein the three phases supplied to each of the pair of coils are a North phase, a South phase, and a neutral phase, wherein the coil group comprises a first coil, a second coil and a third coil.

3. The stored value card of claim 1, wherein the first coil groups and second coil groups are printed on a first layer and a second layer, wherein the coils overlap each other to have complementary magnetic field production.

4. The stored value card of claim 1, wherein the coils are configured to have three phase six step coil control, wherein three phases correspond to three orientations, namely a North orientation, a South orientation and a neutral orientation, wherein in the neutral orientation, the coil does not have current flowing through it.

5. The stored value card of claim 4, wherein in a first phase, the first coil has a North orientation, the second coil has a South orientation, the third coil has a neutral orientation, the fourth coil has a North orientation, the fifth coil has a South orientation and the sixth coil has a neutral orientation.

6. A stored value card comprising:
a. a housing including an upper shell and a lower shell forming a space between the shells, wherein the housing forms a slot shaped to receive a card;
b. a rotating element having a graphic image imprinted on the disc, wherein the rotating element rotates by an electrical motor, wherein the upper shell has a window allowing viewing of at least a portion of the rotating element;
c. a lighted element illuminating the rotating element;
d. an account identifier signifying a financial account linked to the stored value card, wherein the account identifier is on the housing.

7. The stored value card of claim 1, further comprising an electronic controller supplying three phases to a first and a second coil groups for at least a pair of coils, wherein the three phases supplied to each of the pair of coils are a North phase, a South phase, and a neutral phase, wherein the coil group comprises a first coil, a second coil and a third coil.

8. The stored value card of claim 1, wherein the first coil groups and second coil groups are printed on a first layer and a second layer, wherein the coils overlap each other to have complementary magnetic field production.

9. The stored value card of claim 1, wherein the coils are configured to have three phase six step coil control, wherein three phases correspond to three orientations, namely a North orientation, a South orientation and a neutral orientation, wherein in the neutral orientation, the coil does not have current flowing through it.

10. The stored value card of claim 9, wherein in a first phase, the first coil has a North orientation, the second coil has a South orientation, the third coil has a neutral orientation, the fourth coil has a North orientation, the fifth coil has a South orientation and the sixth coil has a neutral orientation.

11. A stored value card comprising:
a. a housing including an upper shell and a lower shell forming a space between the shells, wherein the housing forms a slot shaped to receive a card;
b. a rotating element having a graphic image imprinted on the disc, wherein the rotating element rotates by an electrical motor, wherein the upper shell has a window allowing viewing of at least a portion of the rotating element;
c. a speaker element providing sound;
d. an account identifier signifying a financial account linked to the stored value card, wherein the account identifier is on the housing.

12. The stored value card of claim 1, further comprising an electronic controller supplying three phases to a first and a second coil groups for at least a pair of coils, wherein the three phases supplied to each of the pair of coils are a North phase, a South phase, and a neutral phase, wherein the coil group comprises a first coil, a second coil and a third coil.

13. The stored value card of claim 1, wherein the first coil groups and second coil groups are printed on a first layer and a second layer, wherein the coils overlap each other to have complementary magnetic field production.

14. The stored value card of claim 1, wherein the coils are configured to have three phase six step coil control, wherein three phases correspond to three orientations, namely a North orientation, a South orientation and a neutral orientation, wherein in the neutral orientation, the coil does not have current flowing through it.

15. The stored value card of claim 9, wherein in a first phase, the first coil has a North orientation, the second coil has a South orientation, the third coil has a neutral orientation, the fourth coil has a North orientation, the fifth coil has a South orientation and the sixth coil has a neutral orientation.
